(19) United States
(12) Patent Application Publication
(10) Pub. No.: US 2022/0391667 A1
(43) Pub. Date: Dec. 8, 2022

(54) PROCESSING ULTRAHYPERBOLIC REPRESENTATIONS USING NEURAL NETWORKS

(71) Applicant: Nvidia Corporation, Santa Clara, CA (US)

(72) Inventor: Marc Law, Ontario (CA)

(21) Appl. No.: 17/827,132

(22) Filed: May 27, 2022

Related U.S. Application Data
(60) Provisional application No. 63/194,683, filed on May 28, 2021.

(51) Int. Cl. G06N 3/04; G06N 5/04

(52) U.S. Cl. CPC G06N 3/04; G06N 5/04

(57) ABSTRACT

Approaches presented herein use ultrahyperbolic representations (e.g., non-Riemannian manifolds) in inferencing tasks—such as classification—performed by machine learning models (e.g., neural networks). For example, a machine learning model may receive, as input, a graph including data on which to perform an inferencing task. This input can be in the form of, for example, a set of nodes and an adjacency matrix, where the nodes can each correspond to a vector in the graph. The neural network can take this input and perform mapping in order to generate a representation of this graph using an ultrahyperbolic (e.g., non-parametric, pseudo- or semi-Riemannian) manifold. This manifold can be of constant non-zero curvature, generalizing to at least hyperbolic and elliptical geometries. Once such a manifold-based representation is obtained, the neural network can perform one or more inferencing tasks using this representation, such as for classification or animation.

### CROSS-REFERENCE TO RELATED APPLICATION

This application claims priority to U.S. Provisional Application Ser. No. 63/194,683, filed May 28, 2021, entitled “Ultrahyperbolic Graph Neural Networks,” which is hereby incorporated herein in its entirety for all purposes.

### BACKGROUND

For various inferencing tasks, features or data useful for these tasks are often encoded into a latent space or graph, where each instance of data may be represented by a point, node, or embedding, as may correspond to a feature vector generated for that instance. For certain types of data or inferencing tasks, however, representing the data in a conventional latent space or graph can lead to inaccurate inferencing results, as the data may be unable to be sufficiently represented for accurate processing by the neural network.

### BRIEF DESCRIPTION OF THE DRAWINGS

Various embodiments in accordance with the present disclosure will be described with reference to the drawings, in which:

FIG. 1 illustrates an example classification pipeline, in accordance with at least one embodiment;

FIG. 2 illustrates different classifications that can be performed on a given graph, in accordance with at least one embodiment;

FIG. 3 illustrates an example system ultrahyperbolic manifold representation, according to at least one embodiment;

FIGS. 4A and 4B illustrate projections and vector representations for both hyperbolic and elliptical graphs, according to at least one embodiment;

FIG. 5 illustrates an example process for mapping representations and performing classification, according to at least one embodiment;

FIG. 6 illustrates components of a distributed system that can be used to perform inferencing, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various embodiments of the present disclosure can map data on an input graph (or other such input representation, such as a latent space) to an ultrahyperbolic representation (e.g., a non-Riemannian manifold) for use in various inferencing tasks that may be performed by one or more neural networks. A neural network may receive, as input, a hierarchical graph including data on which to perform an inferencing task, such as a classification task. This input can be in the form of, for example, a set of nodes and an adjacency matrix, where the nodes can each correspond to a vector in the graph. The neural network can take this input and perform mapping in order to generate a representation of this graph on an ultrahyperbolic manifold (or other general manifolds not limited to Riemannian). This manifold can be of constant non-zero curvature, generalizing to at least hyperbolic and/or elliptical geometries. Once a manifold-based representation is obtained, the neural network can perform one or more inferencing tasks using this representation, such as for classification or animation. In some embodiments, this can be a spatiotemporal manifold that can represent changes in the data over time.

Various other such functions can be used as well within the scope of the various embodiments as would be apparent to one of ordinary skill in the art in light of the teachings and suggestions contained herein.

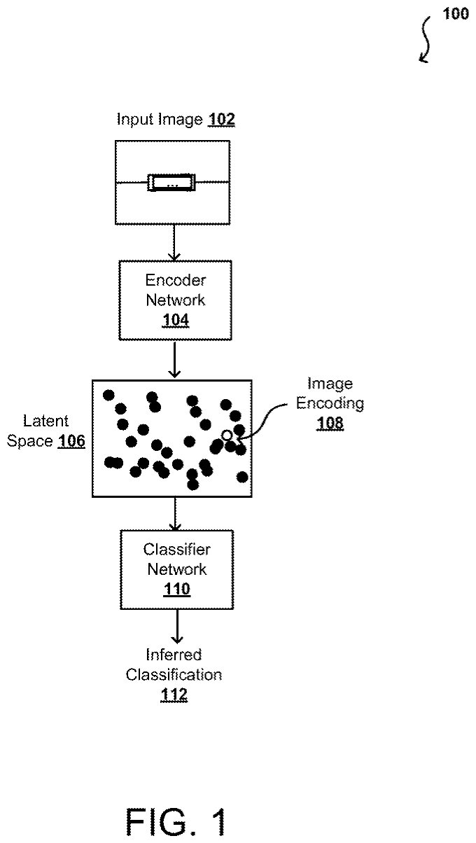

In order to perform various inferencing tasks, components such as machine learning models (MLMs) (e.g., neural networks) may use one or more data representations. As mentioned, these may correspond to a graph (e.g., a directed or hierarchical graph), a set of embeddings, and/or a latent space, among other such options. When input is received for which inferencing is to be performed, this input can be compared against, or evaluated alongside, such a data representation. For example, consider the classification pipeline 100 illustrated in FIG. 1. In this example, an encoder network 104 may process a set of training images to generate a latent space 106 that contains points inferred and encoded for these individual training images. Although shown in two dimensions, the latent space may be of any number of dimensions, as may relate to the type of inferencing to be performed, a type of encoding selected, an amount of compression desired, and/or the type of data to be encoded, among other such options. In some embodiments, each point in this latent space 106 may correspond to a feature vector of a given dimension, where data for an individual dimension may correspond to a feature extracted for that image, such as a representative or unique image feature extracted by a trained neural network-based encoder. Subsequently, when an input image 102 is received for which classification is to be performed, that input image can be processed by the encoder network 104 (or a similar encoder) and encoded into the latent space as a point 108 corresponding to the feature vector generated for that input image 102. In this latent space, the point 108 associated with this input image should be located relatively close to points for similar objects for which similar features were extracted, and further away from points for dissimilar objects for which different features were extracted. This can be useful for a classifier network 110, which can use this latent space to determine, based upon factors such as the relative positions of, or distances between, these points in this latent space, an inferred classification 112 for the object represented in the input image 102—e.g., a clock classification, in this case. In some embodiments, the encoder and classifier can be separate neural networks, where the classifier might be a standalone MLM such as a convolutional neural network (CNN), while in other embodiments the encoder and classifier may be part of the same network, as may include an initial portion (or number of layers) directed to an encoder task (e.g., to generate a representation of the input image 102 in the latent space 106) and a subsequent portion (or number of layers) directed to a classifier or discriminator task, among other such options. Other inferencing tasks can be performed as well, such as to represent objects (e.g., synthetic models) in image generation or synthesis, graphics applications, and/or motion prediction or animation (e.g., skeletal animation in rigging), where there may be some temporal constraints between points in a representation that enable determination as to how these points are related in, and evolve over, time.

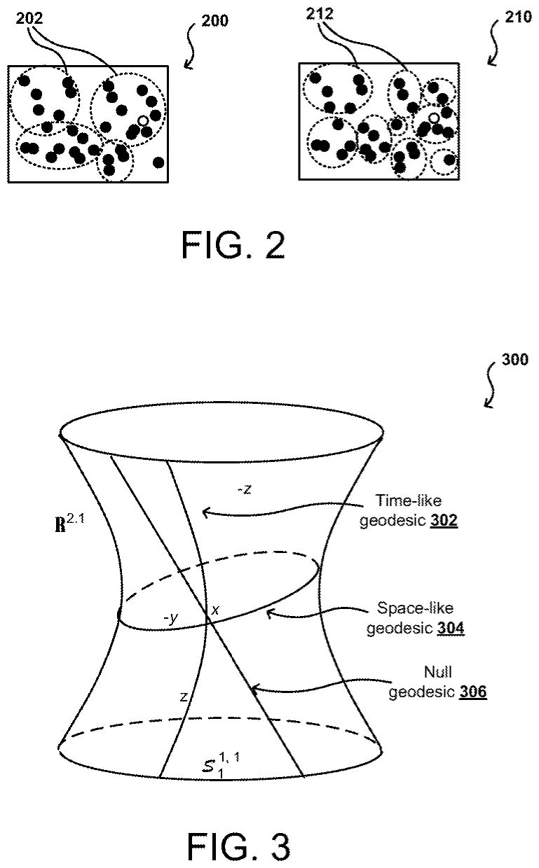

A latent space, embedding space, or other such representation can also be thought of as a graph of n dimensions, where each instance of data represents a point in the graph. For a hierarchical graph representation, each instance of data may represent a node in the graph, where given nodes may serve as a parent and/or child node, and may represent leaf nodes at the ends of paths through the hierarchical graph. There may be different selections used for each of these n dimensions in different embodiments, with some representations generating more accurate inferencing results than other representations. Different forms of graphs or representations may also generate different accuracies in inferencing for different types of data or inferencing tasks. Further, there may be different approaches to determine classifications. For example, consider the classification examples in FIG. 2 for the same representation. A different clustering algorithm, approach, and/or setting used in some embodiments (or distance thresholds in others, etc.) may result in a first set of clusters 202 in a first approach and a second set of clusters 212 in a second approach. Each of these clusters can be associated with a different inferred classification. The accuracy of this clustering can have an impact on the accuracy of the inferencing results, and the optimal type of clustering may vary based on the type of graph or representation, which can also vary for different types of data or inferencing tasks. This can include, for example, performing inferencing on data such as social networks and proteins, which can be quite complex and not easily represented by conventional graphs, particularly with respect to inferencing tasks to be performed by a MLM (e.g., a neural network).

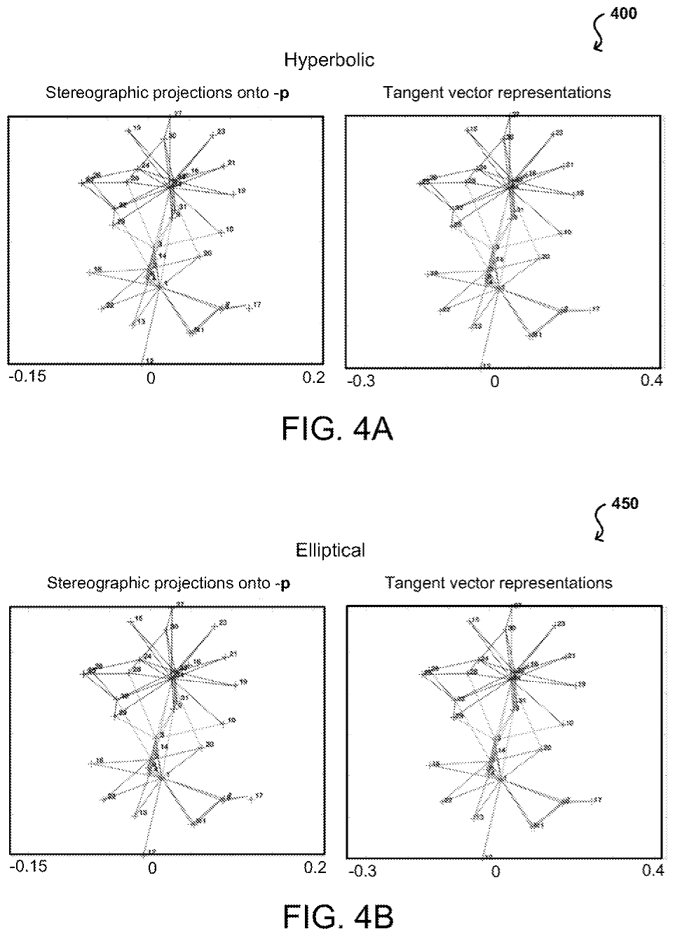

Accordingly, approaches in accordance with various embodiments of the present disclosure attempt to use a representation that provides for more accurate inferencing for various or different types of data. In at least one embodiment, this can include an ultrahyperbolic graph representation 300, such as illustrated in FIG. 3. A neural network can take a graph as input, and can map the points or nodes of the input graph to this hyperbolic graph 300. This hyperbolic graph representation 300 can then be used for the inferencing task, such as a classification task. Such an ultrahyperbolic graph may be non-Riemannian in form—such as a pseudo-Riemannian manifold of constant nonzero curvature—which can generalize to hyperbolic, elliptical, and/or other such geometries. Such geometry can be used for both training and inferencing tasks with respect to a MLM. These geometries can also be used to represent various types of data, such as, without limitation, spatiotemporal data and/or data with directional causality information between nodes of a graphs.

In the ultrahyperbolic manifold 300 of FIG. 3, it is assumed that r=1. In this figure, x and y are connected by a space-like geodesic 304. Therefore, the geodesic distance between x and y is

$$\overline{d} \overline{γ} ( x , y ) = r {cos}^{- 1} ( \frac{{〈 x , y 〉}_{q}}{{r}^{2}} )$$

and the geodesic distance between [x] and [y] is

$${d}_{γ} ( [ x ] , [ y ] ) = r {cos}^{- 1} ( \vert \frac{{〈 x , y 〉}_{q}}{{r}^{2}} \vert ) = {\overline{d}}_{\overline{γ}} ( x , - y ) .$$

In this figure it is also illustrated that x and z are connected by a time-like geodesic 302. Therefore, the geodesic distance between x and z is

$${\overline{d}}_{\overline{γ}} ( x , z ) = r {cosh}^{- 1} ( \frac{{〈 x , z 〉}_{q}}{{r}^{2}} )$$

and the geodesic distance between [x] and [z]

$${d}_{γ} ( [ x ] , [ z ] ) = r {cos}^{- 1} ( \vert \frac{{〈 x , z 〉}_{q}}{{r}^{2}} \vert ) = {\overline{d}}_{\overline{γ}} ( x , z ) .$$

In embodiments, and for completeness, the geodesic “distance” between two points joined by a null geodesic 306 is 0 even if the two points are distinct.

Geodesics of the pseudo-Riemannian quotient manifold P₁^{1,1}=S₁^{1,1}/±1 are embedded in [symbol] ^{2,1}. The point [x] of P₁^{1,1} is the pair {x, −x}. Any pair of points of P₁^{1,1} can be joined by a geodesic of P₁^{1,1}. On the other hand, x and −z cannot be joined by an (unbroken) geodesic of S₁^{1,1}. The length of the minimizing geodesic of P₁^{1,1} joining [x] and [y] is the length of the minimizing geodesic of S₁^{1,1} joining x and −y. The length of the geodesic of joining [x] and [z] is the length of the geodesic of S₁^{1,1} joining x and z.

Referring back to FIG. 1, a latent space 106 and/or graph can be provided as input to a classifier network 110, such as a CNN, which can be trained to map individual points or nodes of the graph to an ultrahyperbolic manifold representation, such as is illustrated in FIG. 3. Such a manifold can provide a topological space that is modeled on Euclidian space locally but may have a variety of global properties, and may also include various local coordinate systems that are related to each other by coordinate transformations belonging to a specified class. Once the data (e.g., embeddings or latent feature vectors along with an adjacency matrix) is represented on this ultrahyperbolic manifold through such a mapping, the classifier network 110 can perform classification using this representation. An adjacency matrix can be used to represent a finite graph, with elements of the matrix indicating whether pairs of the vertices are adjacent in the graph. In at least some embodiments, the network can include a number of layers for computing distances between points on this manifold as part of an inferencing task such as classification. In some embodiments, a graph can be classified by performing aggregation with respect to the various distances as discussed in more detail herein.

Riemannian space forms, such as the Euclidean space, sphere, and hyperbolic space, can provide powerful representation spaces for machine learning. For instance, hyperbolic geometry is appropriate to represent graphs without cycles and has been used to extend Graph Neural Networks (GNNs). Pseudo-Riemannian space forms that generalize both hyperbolic and spherical geometries can be exploited to learn a specific type of (non-parametric) embedding called ultrahyperbolic. The lack of geodesic between every pair of ultrahyperbolic points makes the task of learning parametric models (e.g., neural networks) difficult. Various embodiments can learn parametric models in ultrahyperbolic space, which can be used advantageously for tasks such as graph and node classification.

Riemannian manifolds of constant curvature are common representation spaces in machine learning. They include the Euclidean space (of constant zero curvature), the d-sphere (of constant positive curvature), and the hyperbolic space (of constant negative curvature). The choice of a geometry to represent data can depend, at least in part, on the kind of relationship to be described. For instance, hyperbolic geometry can be used to represent tree-like data, such as for graphs without cycles. Since many hierarchies can be described as trees, hyperbolic representations have been used to represent hierarchical relationships (e.g., hypernymy between words). Nonetheless, in many domains (e.g., social networks or protein structures), hierarchical graphs contain cycles.

In hyperbolic geometry, the considered manifold is not a vector space and is not equipped with the standard dot product. Therefore, most hyperbolic neural networks represent the weights of their last layer in the tangent space of some reference point. That tangent space can be equipped with a positive definite metric tensor and the learned model can then be optimized with Riemannian gradient descent. In particular, since there exists a geodesic between any pair of points, the parameters may be optimized by using parallel transport (also called parallel translation) or the logarithm map. The Riemannian gradients can then be parallel translated to the reference tangent space in which the model parameters lie.

Approaches in accordance with various embodiments can use ultrahyperbolic embeddings. Ultrahyperbolic embeddings may correspond to a type of embedding that lies on a pseudo-Riemannian manifold of constant nonzero curvature. Pseudo-Riemannian manifolds (also called semi-Riemannian manifolds) are generalizations of Riemannian manifolds, where the nondegenerate metric tensor is not constrained to be positive definite. In particular, when the metric tensor is not positive definite, such as when the metric tensor is indefinite, the negative of the (pseudo-Riemannian) gradient is not a descent direction. Various approaches can calculate a descent direction and learn ultrahyperbolic (e.g., nonparametric) embeddings. An advantage to representing data on an ultrahyperbolic manifold is that such a manifold can contain both hyperbolic and spherical portions or regions, as illustrated in FIG. 3. This can then be used to describe any relationship specific to these geometries, such as to represent parts of a graph that are trees or cycles, and can be significantly more flexible. Ultrahyperbolic embeddings have been experimentally shown to be more appropriate than hyperbolic embeddings to represent hierarchical graphs with cycles on several datasets, but since there exist pairs of points on the ultrahyperbolic manifold that cannot be joined by a (unbroken) geodesic, gradients might not be parallel translated via a geodesic and the logarithm map joining two given points might not be defined. Directly extending hyperbolic neural networks to ultrahyperbolic space is then problematic.

Accordingly, various embodiments can instead take a different approach to learning ultrahyperbolic representations with MLMs (e.g., neural networks). In at least one embodiment, a ultrahyperbolic quotient manifold can be considered in which every point x=(x₀, . . . , x_{d})^{T} is equivalent to its antipodal point −x=(−x₀, . . . , −x_{d})^{T}. In this way, for any other pointy, there will exist at least one geodesic joining (x, y) or (−x, y). Conditions can be provided to minimize a function defined on a quotient manifold. Since tangent vectors (hence gradients) of quotient manifolds are abstract objects, this function can be optimized using, for example, a horizontal lift operator. An optimization framework providing such functionality can be at least relatively general, and may support networks such as extended graph neural networks (GNNs), where the activation representations at each layer of a GNN lie in ultrahyperbolic space. A deep ultrahyperbolic model can then be obtained that can be used to represent graphs given as input, and can be used to support different graph classification tasks.

In at least one embodiment, an ultrahyperbolic can be expanded to a quotient manifold denoted by [symbol] ᵣ^{p,q} where (p, q) is the metric signature of the pseudo-Riemannian manifold and 1/r² is its curvature. This has an advantage in that any pair of points of [symbol] ᵣ^{p,q} can be joined by at least one geodesic, which allows for optimization of parametric models. An approach can consider three pseudo-Riemannian manifolds [symbol] ᵣ^{p,q} ⊂ [symbol] ᵣ^{p,q}⊂ [symbol] ᵣ^{p,q} as defined below. It can be observed that [symbol] generalizes elliptic and hyperbolic geometries in special cases, such as where q=0 and p=0, respectively. Points on a smooth manifold [symbol] can be denoted by boldface Roman characters x∈ [symbol] . In this example, [x]:={x, −x} is a pair of antipodal points. Tₓ [symbol] is the tangent space of [symbol] at x, and tangent vectors ξ∈Tₓ [symbol] . [symbol] is the d-dimensional Euclidean space equipped with the (positive definite) dot product <⋅, ⋅> defined as [symbol] x, y [symbol] :=x^{T}y. I is the identity matrix. The inverse function of the cosine (resp. hyperbolic cosine) is denoted by cos⁻¹ (resp. cosh⁻¹).

In this example, ambient space [symbol] ^{p+1,q} is a vector space of dimensionality d+1=p+q+1 ∈ [symbol] called pseudo-Euclidean. It is equipped with the following scalar product (e.g., non-degenerate symmetric bilinear form) of signature (p+1, q):

∀x=(x₀, . . . ,x_{d})^{T},y=(y₀, . . . ,y_{d})^{T} [symbol] x,y [symbol] _{q}: =Σᵢ₌₀^{p}xᵢyᵢ−Σᵢ₌ₚ₊₁^{d}yᵢyⱼ=x^{T}Gy (1)

where the signature matrix G=G⁻¹=I_{p+1,q} is the (d+1)×(d+1) diagonal matrix with the first p+1 diagonal elements equal to 1 and the remaining q elements equal to −1. [symbol] ^{p+1,q} has p+1 space dimensions and q time dimensions. Since it is a vector space, its tangent space can be identified to the space itself by means of the natural isomorphism Tₓ [symbol] ^{p+1,q}≈ [symbol] ^{p+1,q}. Finally, the Euclidean space [symbol] d⁺¹ is the special case of [symbol] ^{d+1,0} which does not contain a time dimension, and where G=I_{d+1,0}=I.

In at least one embodiment, total space [symbol] ᵣ^{p,q} is a pseudo-sphere, which can correspond to the following hypersurface:

[symbol]

ᵣ^{p,q}:={x∈ [symbol] ^{p+1,q}: [symbol] x,x [symbol] _{q}=r²} (2)

where r>0 is the radius of the pseudo-sphere. It is equivalent to work with [symbol] ᵣ^{p,q} and the pseudo-hyperboloid [symbol] ᵣ^{p,q}:={x∈ [symbol] ^{q,p+1}: [symbol] x, x [symbol] ₚ₊₁=−r²}, as they are anti-isometric. Moreover, the radius r>0 only plays a role of scaling factor and can then be considered to be 1. Finally, both x ∈ [symbol] ᵣ^{p,q} and its antipodal point −x lie on [symbol] ᵣ^{p,q} since [symbol] x, x [symbol] _{q}= [symbol] −x, −x [symbol] _{q}.

Considered as equivalence relation the two-element group {±1} consisting of the identity map x [symbol] x and the antipodal map x [symbol] x. As such, two points x∈Sᵣ^{p,q} and y∈Sᵣ^{p,q} are equivalent if y=x or y=−x. The following projective space can be defined:

Pᵣ^{p,q}:=Sᵣ^{p,q}/±1=Sᵣ^{p,q}/±I={{x,−x}:x∈Sᵣ^{p,q}} (3)

Every point of Pᵣ^{p,q} is an unordered pair that is denoted by [x]:={x, −x}. Since Pᵣ^{p,q} is a projective space, every point [x] E can be interpreted as the intersection of the pseudo-sphere Sᵣ^{p,q} with a line passing through the origin of [symbol] ^{p+1,q}. In some cases, it might be easier to interpret points of Pᵣ^{p,q} as lines through the origin, and to study their properties when they intersect the pseudo-sphere. Each point [x]∈Pᵣ^{p,q} is also a submanifold of Sᵣ^{p,q} and a discrete space. In the following, it will be explained how Pᵣ^{p,q} extends spherical geometry to elliptic geometry (e.g., when q=0), or naturally describes the hyperboloid model of hyperbolic geometry (e.g., when p=0).

In spherical geometry, points lie on the unit d-sphere S_{d}:=s₁^{d,0}={x∈ [symbol] ^{d+1}: [symbol] x, x [symbol] =1}. The geometry of the projective d-space P^{d}:=S^{d}/±1 is called elliptic geometry. Geodesic distances of P^{d} naturally account for the fact that they compare sets. Let d_{γ̅}:s^{d}×s^{d} [symbol] be the geodesic distance of S^{d} (e.g., spherical distance). The geodesic distance between [x]∈P^{d} and [y]∈P^{d} is d_{γ}([x], [y])=in_{a∈[x],b∈[y]}d̅_{γ̅}(a, b). A distance metric may then be computed as in equation (4), below:

d_{γ}([x],[y]):=min{d̅_{γ̅}(x,y),d̅_{γ̅}(−x,y)}=cos⁻¹(| [symbol] x,y| [symbol] )=cos⁻¹(| [symbol] x,y [symbol] _{q}|) (4)

which is the distance metric. The fact that the spherical geometry is antipodally symmetric (e.g., every point can be inverted with respect to the origin) leads to a duplication of geometric information. Identifying each pair of antipodal points to one point eliminates the antipodal duplication in spherical geometry.

The hyperboloid model of hyperbolic geometry is similar to the geometry of P₁^{0,q}(p=0). The q-dimensional manifold S₁^{0,q} ⊂ [symbol] ^{1,q} contains two separate sheets (e.g., two connected components) and is anti-isometric to the hyperboloid of two sheets Q₁^{q,0}. Pairs of antipodal points lying on different sheets of S₁^{0,q} are considered as a single point of P₁^{0,q}. Let x∈S₁^{0,q} and z∈S₁^{0,q} be two points lying on the same sheet of S₁^{0,q}, there exists no geodesic joining x and −z. Their geodesic distance with respect to S₁^{0,q} can then be considered to be d̅_{γ̅}(x, −z)=+∞, and therefore gives:

d_{γ}([x],[y]):=min{d̅_{γ̅}(x,z),+∞}=d̅_{γ̅}(x,z)=cosh⁻¹( [symbol] x,z [symbol] _{q})=cosh⁻¹(| [symbol] x,z [symbol] _{q}|) (5)

which corresponds to a hyperbolic distance metric on a hyperboloid.

A parametric model can be used that learns representations lying on the quotient manifold Pᵣ^{p,q}. When both p and q are positive, the metric tensor of Pᵣ^{p,q} is nondegenerate and indefinite. This means that the manifold is pseudo-Riemannian but not Riemannian due to the lack of positive definiteness of the metric tensor. Pᵣ^{p,q} is also referred to as an indefinite elliptic space. As an example, FIG. 3 illustrates the manifold P₁^{1,1}. An advantage to utilizing Pᵣ^{p,q} is that it is more flexible than hyperbolic and elliptic geometries since it contains hyperbolic and elliptic parts (e.g., time-like geodesic 302 and space-like geodesic 304 in FIG. 3). This flexibility allows a system to better represent graphs that are not entirely trees or cycles, but that contain tree-like or cycle subgraphs.

In at least one embodiment, ultrahyperbolic representations lie on the quotient manifold Pᵣ^{p,q}. Differential geometry tools can be used to optimize some differentiable function ƒ: Pᵣ^{p,q}→ [symbol] . To this end, a formulation of geodesics of Pᵣ^{p,q} can be used. Tangent vectors of Pᵣ^{p,q} can be formulated as a function of tangent vectors of Sᵣ^{p,q} such as by a horizontal lift operator. Such an operator allows formulating geodesics of Pᵣ^{p,q} as a function of geodesics of Sᵣ^{p,q}.

It can be difficult to work numerically with the tangent space T_{[x]}Pᵣ^{p,q} of Pᵣ^{p,q} at [x] since [x]={x, −x} is an equivalence class. As mentioned, differential geometry tools can be used to define tangent vectors of Sᵣ^{p,q} as a function of tangent vectors of Pᵣ^{p,q}, and vice versa. In this example, the tangent space Tₓ Sᵣ^{p,q} of Sᵣ^{p,q} at x can be defined as: Tₓ Sᵣ^{p,q}:={ξ∈ [symbol] ^{p+1,q}:(ξ,x)_{q}=0}. The canonical map (or natural map) π: Sᵣ^{p,q}→Pᵣ^{p,q} is defined as: ∀x∈Sᵣ^{p,q}, π(x):=[x]={x, −x}. Its differential at x is denoted by dπₓ: Tₓ Sᵣ^{p,q}→Tₓ Pᵣ^{p,q}. The horizontal space [symbol] ₓ and the vertical space [symbol] ₓ at x∈Sᵣ^{p,q} are subspaces of Tₓ Sᵣ^{p,q} defined such that Tₓ Sᵣ^{p,q}= [symbol] ₓ⊕ [symbol] ₓ is a direct sum of linear spaces, and [symbol] ₓ is the following kernel: [symbol] ₓ:=ker(dπₓ). It can be determined that ker(dπₓ)=Tₓ([x])=0 because [x] is a discrete space so [x] and its tangent spaces are 0-dimensional. This then gives [symbol] ₓ=Tₓ Sᵣ^{p,q}. Elements of [symbol] ₓ are called horizontal vectors, and all the tangent vectors of Sᵣ^{p,q} are horizontal.

The horizontal lift at x∈Sᵣ^{p,q} of the tangent vector ξ∈T_{[x]} Pᵣ^{p,q} is the unique horizontal vector denoted by ξ̅ₓ=liftₓ (ξ)∈ [symbol] ₓ such that dπₓ(ξ̅ₓ)=ξ. Since [symbol] ₓ=Tₓ Sᵣ^{p,q}, the liftₓ operator is bijective so tangent vectors in Tₓ Sᵣ^{p,q} can be equivalently represented by horizontal vectors in [symbol] ₓ. During optimization, this bijection can be exploited, considering only some specific horizontal space to represent and update the weights of the neural network. The fact that [symbol] ₓ=Tₓ Sᵣ^{p,q} is convenient since it implies that any tangent vector in Tₓ Sᵣ^{p,q} can be represented in T_{[x]} Pᵣ^{p,q}. A geodesic of Pᵣ^{p,q} can then be constructed from any geodesic of Sᵣ^{p,q} as discussed herein.

To optimize over Sᵣ^{p,q} an d Qᵣ^{q,∇P}, tools such as the geodesic, parallel transport, exponential map, logarithm map, and geodesic distance d̅_̅{̅γ̅}̅ Sᵣ^{p,q}×Sᵣ^{p,q}→ [symbol] can be defined. These differential geometry tools can be extended to Pᵣ^{p,q}. The geodesic γ̅_{x→ξ}_{ₓ}: [symbol] →sᵣ^{p,q} of Sᵣ^{p,q} is the curve defined such that its initial point is γ̅_{x→ξ}_{ₓ}(0)=x∈Sᵣ^{p,q} its initial velocity is γ̅_{x→ξ}_{ₓ}(0)=ξ̅ₓ ∈Tₓ Sᵣ^{p,q} and its acceleration is zero. When the initial conditions are clear from the context, the geodesic can be denoted by γ̅ and its indices ignored. Since every geodesic γ̅ of Sᵣ^{p,q} satisfies ∀ₜ, γ(t)∈ [symbol] _{γ̅(t)}, it is called horizontal and γ:=π∘γ̅: [symbol] →Pᵣ^{p,q} is a geodesic of Pᵣ^{p,q}. By the chain rule, this leads to ∀t,γ(t)=dπ_{γ̅(t)}(γ(t)), which implies ∀t, lift_{γ̅(t)}(\acute{γ}(t))=\acute{γ̅}(t). This then gives ∀t∈ [symbol] γ[x]→ξ(t)={γ̅x→ξₓ·(t),γ̅−x→ξ̅₋ₓ(t)} and ξ̅ₓ=−ξ̅₋ₓ is found to preserve the equivalence between antipodal points: γ̅_{x→ξ̅}_{ₓ}(t)=−γ̅_{-x→ξ̅}_{_{−x}}(t).

The exponential map of ρᵣ^{ρ,q} at [x] is the differentiable mapping exp_{[x]}: T_{[x]}ρᵣ^{p,q}→ρᵣ^{p,q} defined such that exp_{[x]}(ξ):=γ_{[x]→ξ}(1)={γ̅_{x→ξ̅}_{ₓ}(1), γ̅−x→ξ̅₋ₓ(1)}. The exponential map of Sᵣ^{p,q} at x by e̅x̅p̅ₓ: TₓSᵣ^{p,q}→Sᵣ^{p,q}. It is defined as e̅x̅p̅ₓ(ξₓ):=γ̅_{x→ξ̅}_{ₓ}(1), and this leads to exp_{[x]}(ξ)=[e̅x̅p̅ₓξ̅ₓ]. In practice, some reference point x can be selected, and a system can and work only with the exponential map e̅x̅p̅ₓ. The logarithm map is the inverse function of the exponential map (e.g., l̅o̅g̅ₓ:=exp_{[x]}⁻¹).

Given the minimizing (unbroken) geodesic γ̅ (e.g., minimizing the arc length) from x=γ̅(0) to y=γ̅(1), the parallel transport [symbol] :TₓSᵣ^{p,q}→T_{y}Sᵣ^{p,q} is a linear isometry such that ∀ξ̅ₓ [symbol] ₓ, [symbol] (ξ̅ₓ, [symbol] ₓ [symbol] q= [symbol] [symbol] (ξ̅ₓ), [symbol] ( [symbol] ₓ) [symbol] q. The parallel transport along γ̅ from x to y (where x and y satisfy [symbol] x, y [symbol] q>−r²) is:

$$( {\overline{ξ}}_{x} ) := {\overline{ξ}}_{x} - \frac{〈 y , {\overline{ξ}}_{x} 〉 q}{〈 x , y 〉 q + 〈 x , x 〉 q} ( y + x ) = {\overline{ξ}}_{x} - \frac{〈 y , {\overline{ξ}}_{x} 〉 q}{〈 x , y 〉 q + {r}^{2}} ( y + x ) \qquad ( 6 )$$

A parallel transport on Pᵣ^{p,q} depends on a minimizing geodesic γ whose arc length (that is called geodesic distance d_{γ}) from [x]=γ(0) to [y]=γ(1) is:

$$∀ [ x ] ∈ {P}_{r}^{p , q} , {d}_{\overline{γ}} ( [ x ] , [ y ] ) = \{ \begin{matrix}r {cosh}^{- 1} ( \vert \frac{〈 x , y 〉 q}{{r}^{2}} \vert ) & if \vert \frac{〈 x , y 〉 q}{{r}^{2}} \vert \geq 1 \\ r {cos}^{- 1} ( \vert \frac{〈 x , y 〉 q}{{r}^{2}} \vert ) & otherwise\end{matrix} \qquad ( 7 )$$

and d̅_{γ̅}(x, y)<d̅_{γ̅}(−x, y) if [symbol] x, y [symbol] [symbol] q>0. The parallel transport [symbol] on Pᵣ^{p,q} can be horizontally lifted on [symbol] _{y} as discussed herein:

$${lift}_{y} ( ( ξ ) ) = \{ \begin{matrix}( {\overline{ξ}}_{x} ) & if 〈 x , y 〉 q > 0 \\ ( {\overline{ξ}}_{- x} ) & if 〈 x , y 〉 q < 0\end{matrix} \qquad ( 8 )$$

If (x, y)_{q}=0, then d̅_{γ̅}(x, y)=d̅_{γ̅}(−x,y) and there exist two minimizing geodesics joining [x] and [y]. In practice, one of these two geodesics can be chosen arbitrarily when (x, y)_{q}=0.

It can be advantageous in at least on embodiment to minimize some differentiable function ƒ: Pᵣ^{p,q}→ [symbol] . There may be two properties that ƒ can satisfy. Every [x]∈Pᵣ^{p,q} can be a set of equivalent elements that preserves invariance. To simplify explanations, function ƒ̅: Sᵣ^{p,q}→ [symbol] can be defined such that ƒ̅:=ƒ∘π. This then gives ∀x∈Sᵣ^{p,q}, ƒ̅(x)=ƒ([x]). As a first property, since x and −x are equivalent, the first property that ƒ has to satisfy is ƒ̅(x)=ƒ̅(−x). As a second property, let ∇ƒ̅(x):=(∂ƒ̅(x)/∂x₀, . . . , ∂ƒ̅(x)/∂x_{d})^{T} be the Euclidean gradient of ƒ̅ at x=(x₀, . . . , x_{d})^{T}. The pseudo-Riemannian gradient of ƒ̅ at x∈Sᵣ^{p,q} is Dƒ̅(x):=(G−¹∇ƒ̅(x))=Πₓ (G∇ƒ̅(x))∈TₓSᵣ^{p,q} where

$${\prod }_{x} ( z ) := z - \frac{{( z , x )}_{q}}{{( x , x )}_{q}} x$$

is the orthogonal projection of z onto TₓSᵣ^{p,q}. Let Dƒ([x])∈T(_{[x]})Pᵣ^{p,q} be the pseudo-Riemannian gradient of ƒ at [x]∈Pᵣ^{p,q}. By applying the chain rule, the second property that ƒ has to satisfy is liftₓ (Dƒ([x]))=Dƒ̅(x)=−Dƒ̅(−x).

A function ƒ: Pᵣ^{p,q}→ [symbol] can be minimized that takes as input the ultrahyperbolic representation returned by some parametric model φθ (e.g., a neural network with parameters θ) to be learned. Such an approach can exploit the fact that, due to the properties of the (affine) Levi-Civita connection of Pᵣ^{p,q}, the metric of the manifold Pᵣ^{p,q} is preserved when working with its tangent spaces via the exponential map. In a forward pass, an example can consider the positive pole p=(r, 0, . . . , 0)^{T} ∈Sᵣ^{p,q} defined such that only its first element r>0 is nonzero. The horizontal space of p can be defined as the following vector space [symbol] p=TpSᵣ^{p,q}={0}× [symbol] ^{p,q}. The mapping φθ: [symbol] → [symbol] ₚ maps any input data x∈ [symbol] to [symbol] ₚ and the resulting horizontal vector is mapped to Sᵣ^{p,q} with the exponential map as follows x:=e̅x̅p̅ₚ (φθ(x))∈Sᵣ^{p,q}. As mentioned herein, working with the vector space [symbol] ₚ greatly simplifies computations and preserves the metric thanks to the Levi-Civita connection of Pᵣ^{p,q}. For standard neural networks that map to [symbol] ^{d}, the tangent space is identified to the space itself by the natural isomorphism [symbol] so the network weights also implicitly lie in the tangent space. Such an approach extends Euclidean neural networks to Pᵣ^{p,q}.

In a backward pass, it can be assumed that the function f:Sᵣ^{p,q→} [symbol] satisfies the properties mentioned elsewhere herein. By exploiting equation (8), above, the horizontal lift of the parallel translate of the gradient Dƒ([x]) can be formulated as follows:

$${λ}_{[ x ] , p} := {lift}_{p} ( ( Df [ x ] ) ) ) = \{ \begin{matrix} & ( D \overline{f} ( x ) ) & if {〈 x , p 〉}_{q} \geq 0 \\ & ( D \overline{f} ( x ) ) & otherwise\end{matrix} . \qquad ( 9 )$$

When the metric tensor of the manifold is not positive definite, the manifold is not Riemannian and the negative of λ_{[x],p} is not a descent direction. The negative of Gλ_{[x],p} ∈ [symbol] ₚ is a descent direction that can be used to optimize the parameters of φθ with standard descent algorithms. An optimizer can exploit efficient closed-form expressions on Sᵣ^{p,q} by considering x or its antipodal point −x depending on its “geodesic distance” with the positive pole p. This geodesic distance depends only on the sign of x, p_{q}, which is also the sign of the first element of x=(xc, . . . , xd)^{T} (e.g., d̅_{γ̅}(−x,p)⇔ if [symbol] x, p [symbol] _{q}>0⇔x₀d>0). Operators can generalize tools used in hyperbolic space and are then as efficient as hyperbolic approaches.

Hyperbolic graph neural networks can also be extended to Pᵣ^{p,q}. Graph Neural Networks (GNNs) can be interpreted as parametric models performing message passing between nodes of a graph. The formulation of Graph Convolutional Networks (GCNs) can be used and rewritten with quotient manifolds. Let G=(V, E) be an undirected graph containing n=|V| nodes and m=|E| edges. Its adjacency matrix is denoted by A=∈ [symbol] ^{n×n}. To account for self-loops, the matrix

$$\tilde{A} = {D}^{- \frac{1}{2}} ( A + I ) {D}^{- \frac{1}{2}}$$

can be considered, where D is the diagonal degree matrix defined such that Dᵢᵢ=Σ(Aᵢⱼ+Iᵢⱼ). The vector representation of node v at step k is denoted by hᵥ^{k}∈ [symbol] ^{d}, and hᵥ⁰ is given. W^{k} is a matrix whose elements are the trainable parameters of the k-th layer. The information in the Euclidean GCN propagates as: hᵤ^{k+1}:=σ(Σ_{v∈I(u)})Ãᵤᵥ W^{k} hᵥ^{k}) where I(u) is the set of in-neighbors of u∈V (e.g., u and v are joined by an edge) and σ is a nonlinear activation function such as the element-wise Rectified Linear Unit (ReLU) or its variants.

In such an approach it can be considered that ∀, v, k, hᵥ^{k}∈Pᵣ^{p,q}. Since Pᵣ^{p,q} is not a vector space, the operation W^{k}hᵥ^{k} is not defined, and the activation function σ may be adapted. Properties of the Levi-Civita connection can be exploited to work with the tangent spaces of Pᵣ^{p,q} via the exponential map and its inverse (e.g., logarithm map). The propagation can then be extended to Pᵣ^{p,q} by:

hᵤ^{k+1}:=σ([Σ_{v∈I(u)}ÃᵤᵥW^{k}liftₚ(log_{[p]}(hᵥ^{k})]∈Pᵣ^{p,q}) (10)

where p=(r, 0, . . . , 0)^{T} is the positive pole and the logarithm map is exploited to map points of Pᵣ^{p,q} to a single tangent space. In practice, the horizontal lift operator can be used so that the exponential and logarithm maps only consider the horizontal space [symbol] ₚ during optimization. The hyperbolic GNN corresponds to the special case where Pᵣ^{p,q}=P₁^{0,q} (e.g., p=0).

For simplicity, it can be considered that the radius of Sᵣ^{p,q} is r=1. To enforce nonlinearity between the different layers of the hyperbolic graph neural network, the activation function can be formulated as the result of a steoreographic projection onto the negative pole −p from the hyperboloid model to the Poincare ball, followed by a ReLU activation (in the Poincare ball) and an inverse steoreographic projection from the Poincare ball to the hyperboloid. This can be generalized to pseudo-spheres. Let ε∈{−1,1}. The pole εp=(ε, 0, . . . , 0^{T}) is positive if ε=1, and negative if ε=−1. Consider a point x=(x₀, x₁, . . . , x_{d})^{T}∈S₁^{p,q} with x₀>0 (e.g., lying on the positive hemisphere). The stereographic projection of x onto εp is

$$a = {ω}_{ε} ( x ) := \frac{1}{1 - ε {x}_{0}} {( {x}_{1} , {x}_{2} , … , {x}_{d} )}^{⊤} .$$

If x₀<0, it can equivalently be considered that a=ω_{ε}(−x)=−ω_{-ε}(x) instead of ω_{ε}(x) due to the quotient nature of Pᵣ^{p,q} and to account for the fact that [x] is projected onto the pole of different hemisphere if ε=−1, or same hemisphere if ε=1. The inverse projection of a=(a₁, . . . , a_{d})^{T}∈ [symbol] ^{p,q} is:

$${ω}_{ε}^{- 1} ( a ) := \frac{1}{1 + {〈 a , a 〉}_{q}} ( \begin{matrix}ℰ ( {〈 a , a 〉}_{q} - 1 ) \\ 2 a\end{matrix} ) ∈ {𝒮}_{1}^{ρ , q} where {〈 a , a 〉}_{q} := {\sum }_{i = 1}^{ρ} {a}_{i}^{2} - {\sum }_{j = p + 1}^{d} {a}_{j}^{2} \qquad ( 11 )$$

σ([x]) may be formulated as σ([x]):=[ω_{ε}⁻¹ (ReLU(ω_{ε}(x)))], if x₀>0, and σ([x]):=[ω_{ε}⁻¹ (ReLU(ω_{ε}(−x)))], otherwise, where ReLU (or one of its variants such as LeakyRelu) is applied element-wise only on the q time dimensions of the input vector, which avoids having a zero denominator. ε=−1, in embodiments.

Generalization performance of a GCN can be evaluated in the semi-supervised node classification task on three citation network datasets: Citeseer, Cora, and Pubmed. They contain sparse bag-of-words feature vectors for each document and a list of citation links between documents. Each document is a node and has a class label. Each citation link is an undirected edge. During training, as an example, some of (e.g., all) the nodes and edges are preserved, but only 20 nodes per class are labeled, and 500 nodes are used for validation in total, the rest for test. A GCN with 2 hidden layers can be learned. When the dimensionality of each layer is d=600, all the Euclidean (e.g., standard), Hyperbolic and Ultrahyperbolic GCNs reach the same test accuracy because the model is overparameterized and quickly attains 100% accuracy on the training set. Due to the problem mentioned above, GCNs can be trained whose dimensionality of each layer is d=4 with 100 random initializations. Results were observed to show the superiority of ultrahyperbolic representations in low-dimensional space for node classification of hierarchical graphs with cycles. Such an approach was also evaluated on commonly-used graph kernel benchmark datasets. The results show that ultrahyperbolic representations significantly improve performance on the D&D and Enzymes datasets, which are protein datasets.

Approaches thus can provide neural networks that map data to a (quotient) pseudo-Riemannian manifold of constant nonzero curvature. Such geometry generalizes to at least hyperbolic and elliptic geometries. Such a network can map data to a non-Riemannian manifold, using a framework that can be applied to many parametric models and tasks. This was demonstrated via graph convolutional networks and showed improved performance compared to Euclidean and hyperbolic approaches to represent hierarchical graphs in different tasks. Such an approach can be applied to hierarchical graphs that could represent social networks.

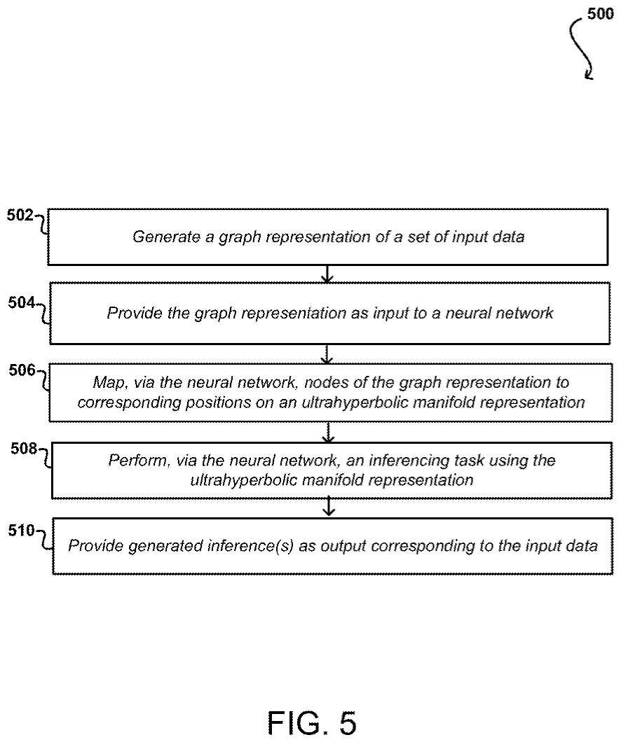

In machine learning, when hyperbolic embeddings are used to represent hierarchies or trees, a standard way to determine the importance of nodes is to compare the Euclidean norm of the embeddings in the Poincare ball (or equivalently on the hyperboloid). High-level nodes tend to have smaller Euclidean norm in hyperbolic geometry. Different scores are observed when the Euclidean norm of the learned hyperbolic representations is used as a proxy of the importance. It was observed that the [symbol] ₂-norm is a worse indicator of importance than δᵢ scores due to the presence of cycles in a graph. This observation is also in accordance with the qualitative two-dimensional results illustrated in the graphs 400 of FIG. 4A where nodes v₁ and v₃₄ do not lie closer to the origin than other nodes. In FIG. 4A, the left graph illustrates a stereographic projection of learned hyperbolic node representations in P₁^{0,2}. In the machine learning literature, they are also called Poincare representations. On the right is illustrated a graph of tangent vector representations of node representations. For every node representation [symbol] [x [symbol] ᵢ]∈P₁^{1,1}, the last two elements of its tangent vector representation are plotted: εᵢ=liftₚ(log_{[p]} [symbol] ([x [symbol] ᵢ])ϵHₚ={0}× [symbol] ^{0,2}. In such an example, since the represented graph is not a tree, the high-level nodes (e.g., nodes v₁ and v₃₄) do not have smaller Euclidean norm than other nodes in the hierarchy. In the graphs 450 of FIG. 4B, the graph on the left illustrates a stereographic projection of learned elliptic node representations in P₁^{2,0}. The graph on the right illustrates tangent vector representations of node representations. For every node representation [symbol] [x [symbol] ᵢ]ϵP₁^{2,0}, the last two elements of its tangent vector representation are plotted: εᵢ=liftₚ (log_{[p]}([xᵢ]))ϵHₚ={0}× [symbol] ².

As mentioned, [symbol] ᵣ^{p,q} can contain both hyperbolic and elliptic parts. As described, if all the time dimensions of [symbol] ᵣ^{p,q} are set to 0, then the considered manifold can be written [symbol] ᵣ^{p,0}×{0}, which corresponds to elliptic geometry. Moreover, in spherical geometry, geodesics are all written in the following way:

$${\overline{γ}}_{x \to {\overline{ξ}}_{x}} ( t ) = cos ( \frac{t \sqrt{\vert 〈 {\overline{ξ}}_{x} , {\overline{ξ}}_{x} 〉 \vert}}{r} ) \times + \frac{r}{\sqrt{\vert 〈 {\overline{ξ}}_{x} , {\overline{ξ}}_{x} 〉 \vert}} sin ( \frac{t \sqrt{\vert 〈 {\overline{ξ}}_{x} , {\overline{ξ}}_{x} 〉 \vert}}{r} ) {\overline{ξ}}_{x} \qquad ( 12 )$$

Their formulation is then very similar to the formulation of space-like geodesics presented herein, except that a different scalar product is used. In fact, it corresponds to a special case of this scalar product when the number of time dimensions is zero. If all the space dimensions except one of [symbol] ᵣ^{p,q} are set to 0, then the considered manifold is diffeomorphic to {0}× [symbol] ^{0,q} which corresponds to the hyperboloid model of hyperbolic geometry. Moreover, in the hyperboloid model of hyperbolic geometry, geodesics are all written:

$${\overline{γ}}_{x \to {\overline{ξ}}_{x}} ( t ) = cosh ( \frac{t \sqrt{\vert {〈 {\overline{ξ}}_{x} , {\overline{ξ}}_{x} 〉}_{q} \vert}}{r} ) x + \frac{r}{\sqrt{\vert {〈 {\overline{ξ}}_{x} , {\overline{ξ}}_{x} 〉}_{q} \vert}} sinh ( \frac{t \sqrt{\vert {〈 {\overline{ξ}}_{x} , {\overline{ξ}}_{x} 〉}_{q} \vert}}{r} ) {\overline{ξ}}_{x} \qquad ( 13 )$$

Their formulation is then similar to the formulation of the time-like geodesics discussed herein, except that a larger number of time dimensions is used in the present example. In conclusion, such a proposed geometry can be more general and can manage to describe relationships considered in elliptic and hyperbolic geometries.

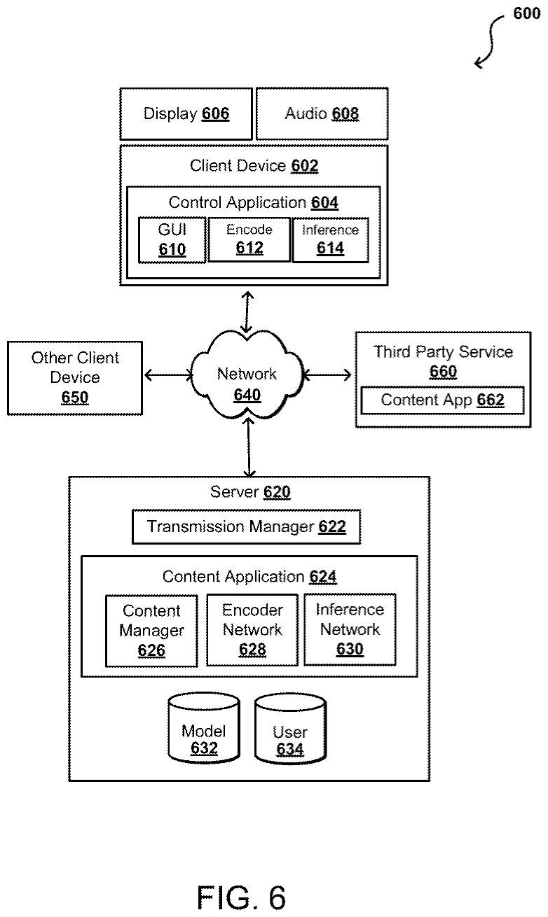

FIG. 5 illustrates an example process 500 for performing classification that can be used in accordance with various embodiments. It should be understood that for this and other processes presented herein that there can be additional, fewer, or alternative steps performed in similar or alternative order, or at least partially in parallel, within the scope of various embodiments unless otherwise specifically stated. In this example, a graph representation is generated 502 (or obtained) for a set of input data. As mentioned, this graph may take various forms, such as a hierarchical or directed graph that may contain related, causal, or spatiotemporal data, among other such options. This graph representation can be provided 504 as input to a neural network, such as a CNN, or GCN. Nodes or points of this input graph representation can be mapped 506, via the neural network, to corresponding positions on a ultrahyperbolic manifold representation. An inferencing task can be performed 508, by this neural network, using this ultrahyperbolic manifold representation to generate or more inferences. These generated inferences can then be provided 510 as output corresponding to the set of input data. As mentioned, these inferencing tasks can include various types of tasks, as may relate to classification, animation, or other such tasks.

In various embodiments, approaches presented herein can be lightweight enough to execute on a device such as a client device, such as a personal computer or gaming console, in real time. Such processing can be performed on content that is generated on, or received by, that client device or received from an external source, such as streaming sensor data or other content received over at least one network. In some instances, the processing and/or determination of this content may be performed by one of these other devices, systems, or entities, then provided to the client device (or another such recipient) for presentation or another such use.

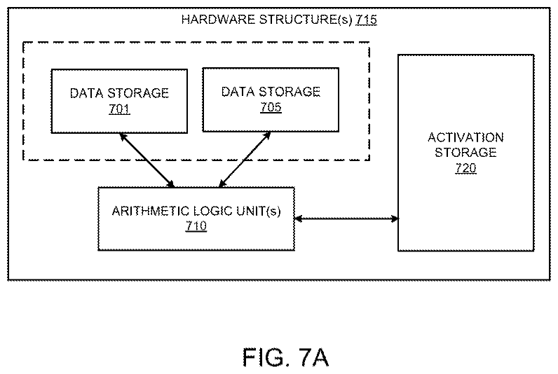

As an example, FIG. 6 illustrates an example network configuration 600 that can be used to provide, generate, modify, encode, and/or transmit data or other such content. In at least one embodiment, a client device 602 can generate or receive data for a session using components of a content application 604 on client device 602 and data stored locally on that client device. In at least one embodiment, a content application 624 executing on a server 620 (e.g., a cloud server or edge server) may initiate a session associated with at least client device 602, as may use a session manager and user data stored in a user database 634, and can cause content 632 to be determined by a content manager 626. A content manager 626 may work with an encoder network 628 and inference network 630 to perform one or more inferences using one or more representation models (e.g., manifolds) from a model database 632, such as to infer a classification for an object. At least a portion of that content (e.g., one or more classifications or inferences, or encoded graphs) may be transmitted to client device 602 using an appropriate transmission manager 622 to send by download, streaming, or another such transmission channel. An encoder may be used to encode and/or compress at least some of this data before transmitting to the client device 602. In at least one embodiment, client device 602 receiving such content can provide this content to a corresponding content application 604, which may also or alternatively include a graphical user interface 610, encoder 612, and inferencing network 614 for use in generating inferences on input data. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 634, to client device 602. In at least one embodiment, at least a portion of this content can be obtained or streamed from another source, such as a third party service 660 or other client device 650, that may also include a content application 662 for generating or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR/AR/MR headset, VR/AR/MR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Inference and Training Logic

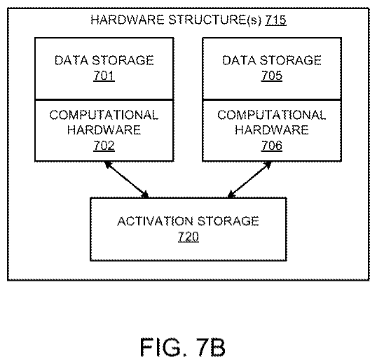

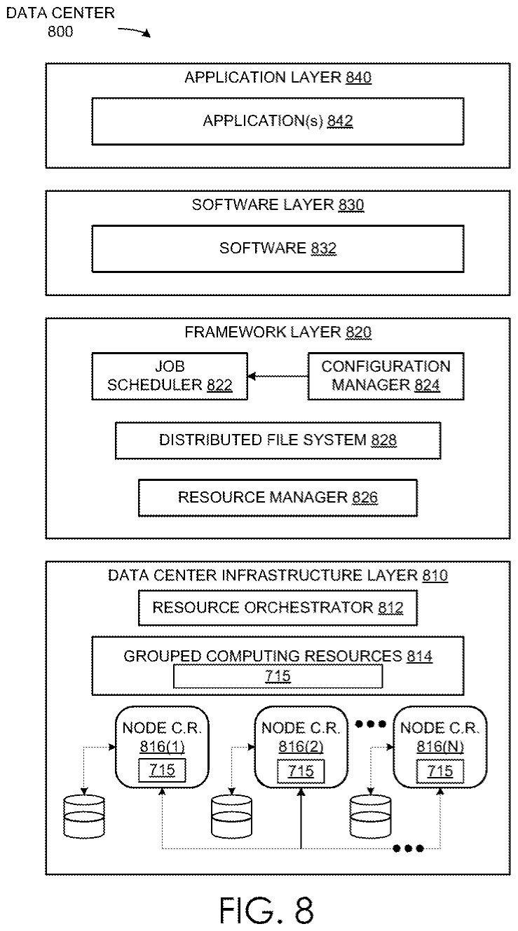

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7a may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7a may be used in conjunction with central processing unit (“CPU”) hardware, graphics processing unit (“GPU”) hardware or other hardware, such as field programmable gate arrays (“FPGAs”).

FIG. 7b illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7b may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7b may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7b, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

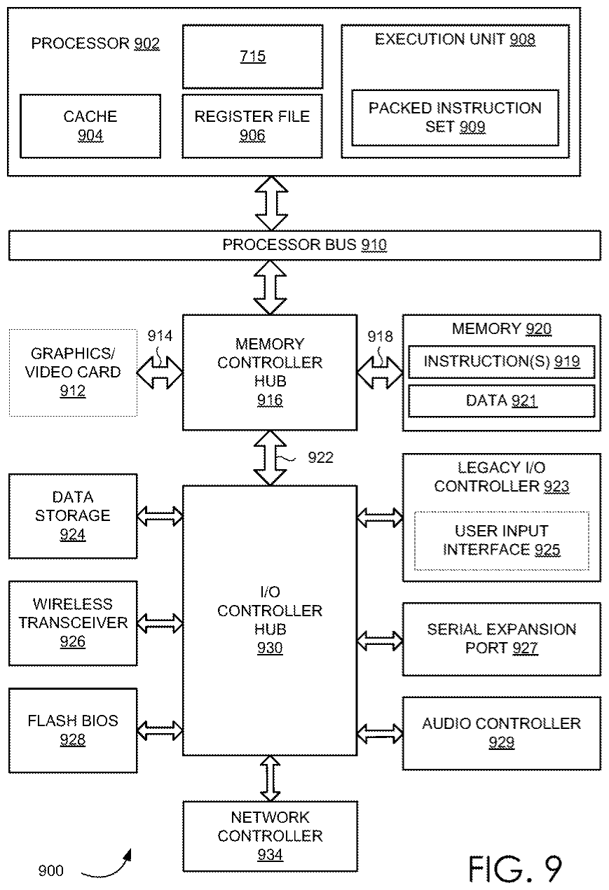

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to map an input graph to an ultrahyperbolic manifold representation for performing one or more inferences

### Computer Systems

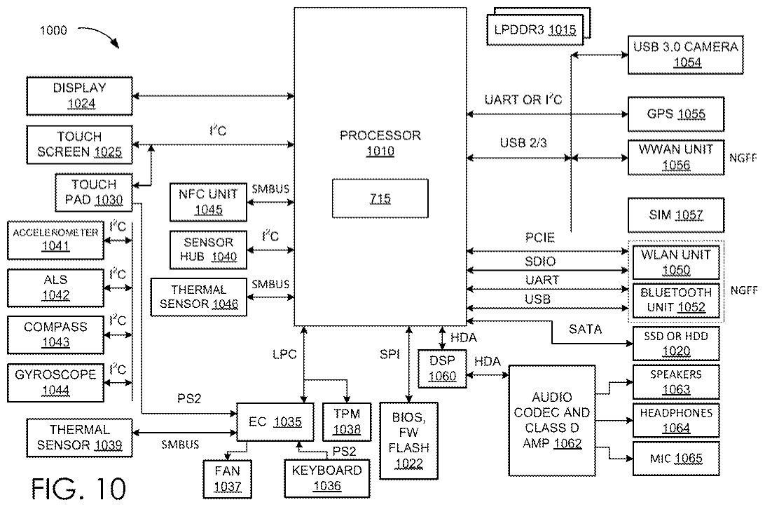

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, Calif., although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to map an input graph to an ultrahyperbolic manifold representation for performing one or more inferences.

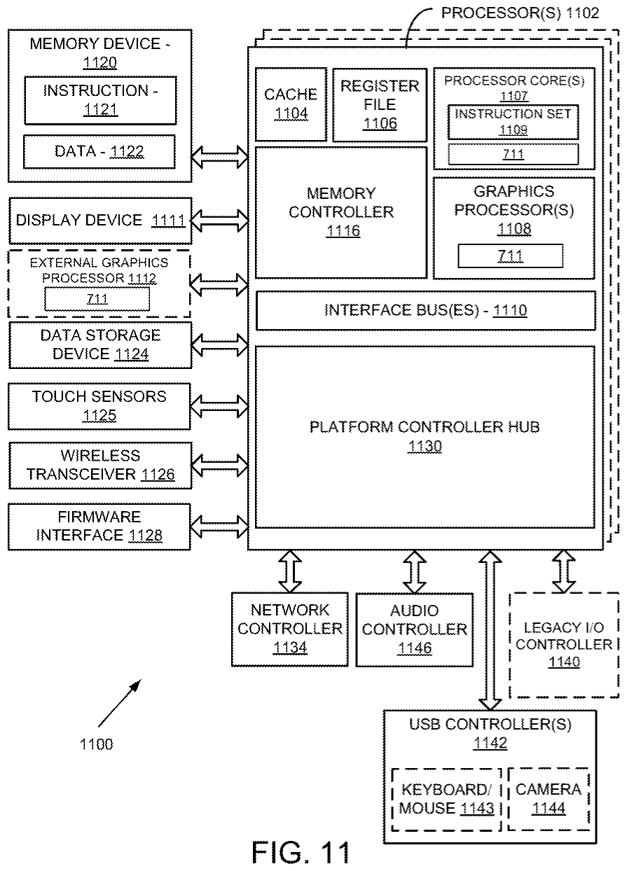

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1046, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1064 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7a and/or 7b. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to map an input graph to an ultrahyperbolic manifold representation for performing one or more inferences.

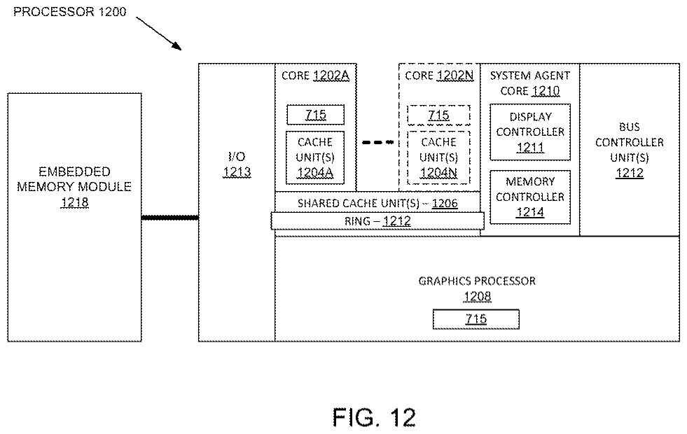

FIG. 11 is a block diagram of a processing system, according to at least one embodiment. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 can have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, can be a processor bus, such as a version of a Direct Media Interface (DMI) bus. In at least one embodiment, interface 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to map an input graph to an ultrahyperbolic manifold representation for performing one or more inferences.

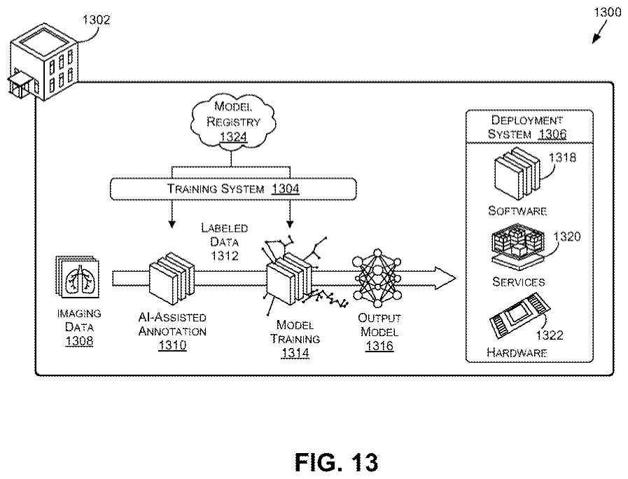

FIG. 12 is a block diagram of a processor 1200 having one or more processor cores 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7a and/or 7b. In at least one embodiment portions or all of inference and/or training logic 715 may be incorporated into processor 1200. For example, in at least one embodiment, training and/or inferencing techniques described herein may use one or more of ALUs embodied in graphics processor 1512, graphics core(s) 1202A-1202N, or other components in FIG. 12. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to map an input graph to an ultrahyperbolic manifold representation for performing one or more inferences.

### Virtualized Computing Platform

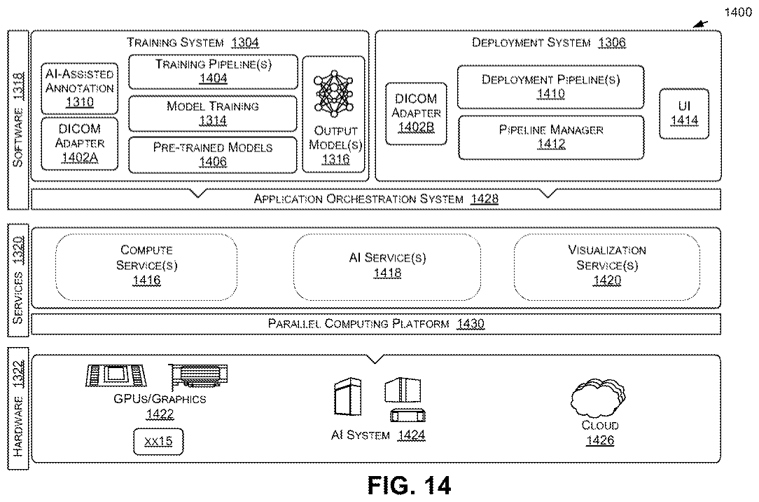

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

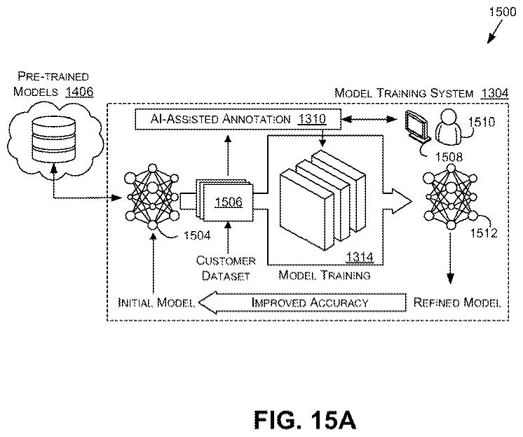

In at least one embodiment, model registry 1324 may be backed by object storage that may support versioning and object metadata. In at least one embodiment, object storage may be accessible through, for example, a cloud storage (e.g., cloud 1426 of FIG. 14) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1404 (FIG. 14) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled clinic data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations.

In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline 1404 (FIG. 14), a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled clinic data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1430 (FIG. 14)). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc. —to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipelines 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

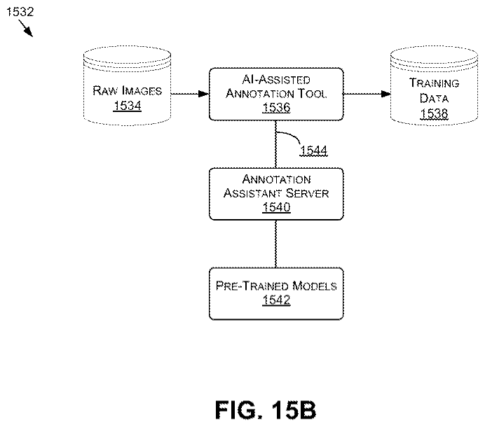

In at least one embodiment, training pipelines 1404 may include AI-assisted annotation, as described in more detail herein with respect to at least FIG. 15B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipelines 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to imaging data (and/or other data types) generated by imaging devices, sequencing devices, genomics devices, etc. —including AI-assisted annotation, as described above. In at least one embodiment, as described herein, a deployment pipeline 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1410 depending on information desired from data generated by a device. In at least one embodiment, where detections of anomalies are desired from an Mill machine, there may be a first deployment pipeline 1410, and where image enhancement is desired from output of an Mill machine, there may be a second deployment pipeline 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipelines 1410 may be even more user friendly, provide for easier integration, and produce more accurate, efficient, and timely results.

In at least one embodiment, deployment system 1306 may include a user interface 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples (e.g., as illustrated in FIG. 12cc) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute services 1416, AI services 1418, visualization services 1420, and/or other service types. In at least one embodiment, applications may call (e.g., execute) one or more of services 1320 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1306. In at least one embodiment, GPUs 1422 (e.g., NVIDIA's TESLA and/or QUADRO GPUs) may include any number of GPUs that may be used for executing processing tasks of compute services 1416, AI services 1418, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute services 1416, AI services 1418, and/or visualization services 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services 1320 and/or hardware 1322 of system 1400, as described herein. In at least one embodiment, refined models 1512 generated by process 1500 may be executed by deployment system 1306 for one or more containerized applications in deployment pipelines 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, or deleted, and/or replaced with an updated or new output or loss layer(s). In at least one embodiment, initial model 1504 may have previously fine-tuned parameters (e.g., weights and/or biases) that remain from prior training, so training or retraining 1314 may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506 (e.g., image data 1308 of FIG. 13).

In at least one embodiment, pre-trained models 1406 may be stored in a data store, or registry (e.g., model registry 1324 of FIG. 13). In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using cloud 1426 and/or other hardware 1322, but confidential, privacy protected patient data may not be transferred to, used by, or accessible to any components of cloud 1426 (or other off premise hardware). In at least one embodiment, where a pre-trained model 1406 is trained at using patient data from more than one facility, pre-trained model 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select a pre-trained model 1406 to use with an application. In at least one embodiment, pre-trained model 1406 may not be optimized for generating accurate results on customer dataset 1506 of a facility of a user (e.g., based on patient diversity, demographics, types of medical imaging devices used, etc.). In at least one embodiment, prior to deploying pre-trained model 1406 into deployment pipeline 1410 for use with an application(s), pre-trained model 1406 may be updated, retrained, and/or fine-tuned for use at a respective facility.

In at least one embodiment, a user may select pre-trained model 1406 that is to be updated, retrained, and/or fine-tuned, and pre-trained model 1406 may be referred to as initial model 1504 for training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility (e.g., as labeled clinic data 1312 of FIG. 13).

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained models 1406 in model registry 1324 to be selected by another facility. In at least one embodiment, his process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tools 1536 may be instantiated based on a client-server architecture 1532. In at least one embodiment, annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-Assisted Annotation Tool 1536B in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines 1404. In at least one embodiment, pre-installed annotation tools may be improved over time as new labeled clinic data 1312 is added.

Such components can be used to map an input graph to an ultrahyperbolic manifold representation for performing one or more inferences.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
mapping, using one or more first layers of a neural network, one or more nodes of a graph to corresponding positions of an ultrahyperbolic embedding space to generate one or more embeddings; and
performing, using one or more second layers of the neural network, an inferencing task using the one or more embeddings.

2. The method of claim 1, wherein the ultrahyperbolic embedding space corresponds to a pseudo-Riemannian manifold of constant non-zero curvature.

3. The method of claim 1, wherein the ultrahyperbolic embedding space corresponds to at least one of a hyperbolic geometry or an elliptical geometry.

4. The method of claim 1, wherein the graph comprises the one or more nodes and an adjacency matrix.

5. The method of claim 1, wherein the one or more nodes correspond to one or more feature vectors generated using an encoder neural network to process input data corresponding to the inferencing task.

6. The method of claim 1, wherein the inferencing task relates to at least one of classification, image generation, motion prediction, or animation.

7. The method of claim 1, wherein the ultrahyperbolic manifold is associated with at least one of: one or more temporal constraints, one or more causal constraints, or one or more spatial constraints.

8. The method of claim 1, wherein the ultrahyperbolic embedding space includes a non-parametric embedding space with a positive-indefinite metric tensor.

9. A system, comprising:
one or more processing units to:
map, using a neural network, one or more nodes of a graph to one or more corresponding positions on an ultrahyperbolic manifold representation; and
perform, using the neural network, an inferencing task based at least in part on the one or more corresponding positions on the ultrahyperbolic manifold representation.

10. The system of claim 9, wherein the ultrahyperbolic manifold representation corresponds to a pseudo-Riemannian manifold of constant non-zero curvature.

11. The system of claim 9, wherein the ultrahyperbolic manifold representation corresponds to at least one of a hyperbolic geometry or an elliptical geometry.

12. The system of claim 9, wherein the graph comprises the one or more nodes and an adjacency matrix.

13. The system of claim 9, wherein the one or more nodes correspond to one or more feature vectors generated using an encoder neural network processing input data corresponding to the inferencing task.

14. The system of claim 9, wherein the inferencing task relates to classification, image generation, motion prediction, or animation.

15. The system of claim 9, wherein the ultrahyperbolic manifold representation is associated with at least one of: one or more temporal constraints, one or more causal constraints, or one or more spatial constraints.

16. The system of claim 9, wherein the system comprises at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

17. A processor comprising:
one or more processing units to:
embed, using a neural network, one or more nodes of a graph into a non-parametric embedding space to generate one or more ultrahyperbolic embeddings;
compute, using the neural network and based at least in part on the one or more ultrahyperbolic embeddings, one or more outputs; and
perform one or more operations based at least in part on the one or more outputs.

18. The processor of claim 17, wherein the non-parametric embedding space corresponds to a semi-Riemannian manifold, the semi-Riemannian manifold having constant non-zero curvature and a positive-indefinite metric tensor.

19. The processor of claim 17, wherein the graph comprises the one or more nodes and an adjacency matrix, and wherein the one or more nodes correspond to one or more feature vectors generated by another neural network based at least in part on the another neural network processing input data corresponding to the one or more operations.

20. The processor of claim 17, wherein the one or more operations include at least one of a classification operation, an image generation operation, a motion prediction operation, or an animation operation.

21. The processor of claim 17, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
